(19) United States
(12) Patent Application Publication
(10) Pub. No.: US 2023/0413880 A1
(43) Pub. Date: Dec. 28, 2023

(54) POWDERED CHICKPEA-PROTEIN BASED EMULSIFER, USES AND METHODS OF MANUFACTURE

(71) Applicant: Corn Products Development, Inc., Westchester, IL (US)

(72) Inventors: Quyen NGUYEN, Bridgewater, NJ (US); Xin YANG, Bridgewater, NJ (US); Christopher ZHANG, Bridgewater, NJ (US)

(21) Appl. No.: 18/252,893

(22) PCT Filed: Oct. 27, 2021
(86) PCT No.: PCT/US2021/056733

§ 371 Date: May 15, 2023

Related U.S. Application Data
(60) Provisional application No. 63/115,404, filed on Nov. 18, 2020.

(51) Int. Cl. A23L 29/10; A23L 11/00; A23J 3/14; A23P 10/47; A23D 7/005; A23L 15/00; A23L 29/231

(52) U.S. Cl. CPC A23L 29/10; A23L 11/05; A23J 3/14; A23L 29/231; A23D 7/0053; A23L 15/35; A23P 10/47

(57) ABSTRACT

The technology disclosed in this specification pertains to a powdered chickpea-protein based emulsifier comprising a soluble chickpea protein and a gelatinized but otherwise unmodified amylopectin. The soluble chickpea protein is not hydrolyzed, and the emulsifier is obtainable by drying the amylopectin and the chickpea protein together. The emulsifier is useful in high oil load and low oil load emulsions and provides emulsions stability against oil separation for at least several months.

The technology disclosed in this specification pertains to a powdered chickpea-protein based emulsifier useful for making long term stable egg-free oil-in-water emulsions.

Many edible composition are emulsions of an oil and an aqueous ingredient. It is common to use emulsifiers like monoglycerides, diglycerides, egg yolks, or modified starches like octenyl-succinic acid modified starches (OSA-starches) to stabilize the interface between the lipid and aqueous ingredients. These emulsifiers, however, may be disfavored in some uses because they are not perceived as being clean label or are from animal sources.

Various types of plant-based proteins and plant-based protein products have been explored as emulsifiers. One is commonly called aquafaba, which is an aqueous composition of chickpea protein and other components and is formed by cooking chickpeas in water; the cooking water is the aquafaba. But it is a less effective emulsifier than monoglycerides, diglycerides, egg yolks and OSA-starches with reference to stabilizing the emulsion from separation of the oil and aqueous phases. So effective clean label ingredients and methods are needed to stabilize aquafaba based emulsions and other chickpea-protein based emulsions.

### BRIEF DESCRIPTION OF THE FIGURES

The technology described in this application can be better understood with reference to the following non-limiting figures.

FIG. 1 shows the mean oil droplet size over time of an oil-in-water emulsion containing a highly inhibited starch.

FIG. 2 shows the mean oil droplet size over time of an oil-in-water emulsion containing an intermediately inhibited starch.

FIG. 3 compares the oil droplet size distribution of two emulsions containing liquid and powdered chickpea-based protein.

FIG. 4 shows microscopy images (200× magnification) of emulsions (mayonnaise) using liquid (left) and spray dried (right) chickpea-based proteins.

The technology disclosed in this specification pertains to a powdered chickpea-protein based emulsifier comprising a soluble, non-hydrolyzed chickpea protein and a pregelatinized but otherwise unmodified amylopectin. In any embodiment, a powdered chickpea-protein, based emulsifier having: (a) a soluble chickpea protein in an amount by weight of the emulsifier of from about 5% to about 40%, or about 10% to about 30%, or about 10% to about 25%, or about 15% to about 25%; and (b) a gelatinized but otherwise unmodified amylopectin in an amount of from about 30% to about 80%, or from about 30% to 60%, or from about 30% to about 50%, or from about 35% to about 45%, or from about 40% to about 45% wherein the soluble chickpea protein is not hydrolyzed and wherein the emulsifier is obtained or obtained by drying the amylopectin and the chickpea protein together.

Amylopectin is gelatinized to facilitate its dissolution in the aqueous phase of the emulsion. It has been found that emulsions prepared with a soluble chick pea protein emulsifier and having dissolved amylopectin in the amounts described in this specification are more stable against oil separation than emulsions prepared with a soluble chick pea protein emulsifier but dissolved amylopectin.

In any embodiment described in this specification, a powdered chickpea-protein based emulsifier has a non-hydrolyzed soluble chickpea protein in an amount from about 5% to about 15%, or from about 5% to about 10% and a gelatinized but otherwise unmodified but otherwise unmodified amylopectin is in an amount from about 70% to about 80%.

In any embodiment described in this specification, a powdered chickpea-protein based emulsifier has a non-hydrolyzed soluble chickpea protein and a gelatinized but otherwise unmodified amylopectin in an amount from about 40% to about 95% (by weight) of the emulsifier, or from about 40% to about 70%, or about 50% and about 70%, or from about 55% and about 70%.

In any embodiment described in this specification, a powdered chickpea-protein based emulsifier has a non-hydrolyzed soluble chickpea protein and a gelatinized but otherwise unmodified amylopectin make up between about 80% and about 90% (by weight) of the emulsifier.

In any embodiment described in this specification, a powdered chickpea-protein based emulsifier has amylopectin from any starch from which amylose is substantially absent in the native granule. In any embodiment described in this specification, a powdered chickpea-protein based emulsifier has amylopectin from any starch that does not have amylose in the native granule. Such starches may be commonly called a waxy starch. In any embodiment described in this specification, a powdered chickpea-protein based emulsifier has amylopectin from a waxy starch. In any embodiment described in this specification, the amount of amylose in the starch may be present in an amount of from about 1% to about 20/a, or from about 1% or about 10%, or about 1% to about 5%, or less than about 10%, or less than about 5%, or less than about 1% (by weight) of the starch. In any embodiment described in this specification, the amount of amylopectin in the starch may be present in an amount of from about 50% to about 100%, or from about 75% or about 100%, or about 90% to about 100%, or greater than about 90%, or greater than about 95%, or greater than about 99% (by weight) of the starch. In any embodiment described in this specification, the amylopectin is from a waxy corn starch, waxy tapioca starch, waxy potato starch, waxy rice starch, or mixture thereof.

In any embodiment the non-hydrolyzed soluble chickpea protein is obtained by any suitable method to separate soluble chickpea protein from chickpeas. Soluble proteins may be obtained for example by soaking whole or milled chickpeas. The chickpeas may be cooked during the process of extracting proteins. Chickpea water may be filtered or centrifuged to separate soluble protein from insoluble protein. In any embodiment described in this specification, a powdered chickpea-protein based emulsifier is obtained or obtainable by a process comprising a) obtaining an aqueous mixture of the chickpea protein and the gelatinized but otherwise unmodified amylopectin; and b) drying the mixture. In embodiments the non-hydrolyzed soluble chickpea protein may be provided to the mixture in a liquid form, such as a chickpea broth or aquafaba. A chickpea broth or aquafaba includes material in addition to non-hydrolyzed soluble chickpea protein that remains part of embodiments of the powdered chickpea-protein based emulsifier.

Notably, although it is expected that a chickpea broth or aquafaba will contain starch, the gelatinized but otherwise unmodified amylopectin is a separate added starch component, which is selected from a waxy starch or waxy starch or is amylopectin that has otherwise been isolated from a mixture of amylose and amylopectin.

In any embodiment described in this specification, a powdered chickpea-protein based emulsifier consists essentially of a soluble chickpea protein, a gelatinized but otherwise unmodified amylopectin and a third component being derived from a chickpea. In any embodiment described in this specification, a powdered chickpea-protein based emulsifier consists of a soluble chickpea protein, a gelatinized but otherwise unmodified amylopectin and one or more additional components derived from a chickpea.

In some embodiments, a powdered chickpea-protein based emulsifier is made in a process that spray dries an aqueous mixture of unmodified amylopectin and non-hydrolyzed soluble chickpea protein. In other embodiments, a powdered chickpea-protein based emulsifier is made in a process that drum dries an aqueous mixture of unmodified amylopectin and non-hydrolyzed soluble chickpea protein. In any embodiment unmodified amylopectin may be gelatinized during drying process or may gelatinized prior to mixing unmodified amylopectin and non-hydrolyzed soluble chickpea-protein or may be gelatinized in an aqueous mixture comprising non-hydrolyzed soluble chickpea-protein. In embodiments where a non-hydrolyzed soluble chickpea protein and unmodified amylopectin are heated together in an aqueous solution the solution is heated at a temperature of from about 90° C. to about 100° C. for at least about 15 minutes, or at about least 20 minutes. In any embodiment described in this specification, the powdered chickpea-protein based emulsifier is obtained by a process wherein the aqueous mixture of the soluble chickpea protein and the gelatinized but otherwise unmodified is not heated prior to drying.

In another aspect the technology disclosed in this specification pertains to a method of making a powdered chickpea-protein based emulsifier comprising: a) obtaining an aqueous mixture having from about 1% to about 3% non-hydrolyzed soluble chickpea protein and from about 2% to about 20% gelatinized but otherwise unmodified amylopectin; and b) drying the mixture. In some embodiments of a powdered chickpea-protein based emulsifier a spray drier is fed an aqueous mixture comprising gelatinized but otherwise unmodified in an amount from about 2% to about 5% or from about 2% to about 3% or from about 3% to about 4%. In yet other embodiments, a powdered chickpea-protein based emulsifier is obtained from an aqueous mixture having total solids content of from about 8 to about 11%, or about 9% to about 10%. In other embodiments of a powdered chickpea-protein based emulsifier is obtained by drum drying. In embodiments described in this specification, a powdered chickpea-protein based emulsifier is made from an aqueous mixture having total solids content from about 10% to about 20% or from about 12% to about 16%, or from about 13% to about 15%. In still other embodiments described in this specification, a powdered chickpea-protein based emulsifier is obtained from an aqueous mixture having total solids content is from about 15% to about 25% or from about 17% to about 22%.

In any embodiment described in this specification of a method for making a powdered chickpea-protein based emulsifier, a non-hydrolyzed soluble chickpea protein is not heated in the presence of a gelatinized but otherwise unmodified amylopectin. In any embodiment of a method for making a powdered chickpea-protein based emulsifier, a non-hydrolyzed soluble chickpea protein is not denatured in the presence of the gelatinized but otherwise unmodified amylopectin prior to drying.

In another aspect, the technology disclosed in this specification pertains to a method of making long term stable, egg free oil-in-water emulsions from a powdered chickpea-protein based emulsifier. In any embodiment, this specification discloses a method of making an oil-in-water emulsion comprising mixing a) a powdered chickpea-protein based emulsifier as described in any foregoing claim in an amount from about 1% to about 4%, or from about 1% to about 3% or from about 1% to about 2%, or from about 1.5% to 2% by weight of the emulsion; b) oil in an amount selected from the group consisting of i) greater than about 65% or greater than about 70% from about 70% to about 80%, or from about 70% to about 75% ii) less than about 50% or from 25% to about 50% to from about 25% to about 40% or from about 25% to about 35% and c) an aqueous ingredient to form the emulsion wherein the emulsion is egg free; and wherein the soluble chickpea protein is not hydrolyzed. In some embodiments a stable, egg-free emulsion is made using a powdered chickpea-protein based emulsifier from about 3% to about 4% by weight of the emulsion.

The disclosed emulsions obtain commercially useful viscosity and stability without the use of a viscosifying agent such as a modified starch, or gum, or hydrocolloid, but such agents can be used in the disclosed emulsions to increase viscosity, or to provide a desired mouth feel or other desired organoleptic effect. Viscosifying agents such as modified starch, gums, and hydrocolloids can be included in amounts suitable to achieve the desired effect using the selected material. In at least some embodiments an emulsion, as described in this specification further includes modified starch in an amount of from about 1% to about 10%, or from about 1% to about 5%. In any embodiment useful modified starches include physically modified starches such as thermally inhibited starches (see e.g. Published PCT Number WO 95/04082 A2). Other useful starches include chemically modified starches that are, for example, phosphate or adipate cross-linked.

In embodiments of a method of making an emulsion using a powdered chickpea-protein based emulsifier, as described in this specification, the only emulsifier used in the method are one or more components of the chickpea-protein based powder.

In embodiments of a method of making an oil-in-water emulsion using a powdered chickpea-protein based emulsifier, as described in this specification, the method comprises mixing an aqueous ingredient having a pH of less than 7 or less than about 6 or from about 3 to about 6.

In embodiments of the method the powdered chickpea-protein based emulsifier may be rehydrated before mixing with oil or other liquid.

Embodiments of egg free emulsion made by any foregoing method have mean oil droplet size from about 10 microns to about 20 microns, or from about 10 microns to about 17 microns or from about 10 microns to about 15 microns and are long term shelf stable. In embodiments the emulsions have a variation of a mean oil droplet size of less that changes by less than about 12.5%, or about less than 10%, or less than about 7%, or less than about 5%, or less than about 2% over 1 month's or 6 months' or 1 year's storage at one or more of 5° C. or 25° C. In other embodiments, emulsion have a variation of a mean oil droplet size that changes by less than about 5 microns over 6 months or 1 year when stored at one or more of 5° C. or 25° C. Emulsions have the foregoing attributes are achievable containing egg or egg components, wherein the powdered chickpea-protein emulsifier is the only emulsifier in the emulsion. Additionally, emulsions having the foregoing attributes are achievable without containing gums or additional stabilizers other than the powdered chickpea-protein based emulsifier and the amylopectin.

Also disclosed in this specification is use of a powdered chickpea-protein based emulsifier as described in any foregoing claim in a food composition in any embodiment of an oil-in-water emulsion as described in this specification.

Reference to “Thermal inhibition” or “thermally inhibited starch” refers to a class of commercial products that mimic the function of chemically crosslinked starches (chemically inhibited starches). The low, medium and high thermally inhibited products referenced in this application are available from Ingredion Incorporated. Starches can be thermally inhibited by a variety of methods disclosed including but not limited to those described in PCT Number WO 95/04082 A2, which is incorporated herein by reference.

Reference to “hydrolysis of a protein” in this specification means an intentional process used to reduce the size of a protein. Hydrolysis reactions commonly involve acid or enzyme to cleave bonds between amino acid.

Reference to the “stability” or “long term stability” of an emulsion within this specification is taken in relative to oil and aqueous phase separation: a stable emulsion does not separate over a time period described in this specification. Stability against oil separation can be quantified by reference changes in the mean oil droplet size of oil droplets within the emulsion over time because smaller oil droplets generally more easily remain dispersed within the aqueous phase than larger oil droplets and increasing in oil droplet size indicates coalescing of oil droplets and the onset of oil separation from the aqueous phase.

Reference to “soluble content” in this specification means the percent of a sample of solids that is dissolvable in solution. Within this specification it measured by reference to the percent of a portion of a sample that has dissolved solution. Most commonly in this specification, soluble content refers to the percent of waxy starch that has dissolved in aqueous solution. The soluble content is not intended to be an absolute but is taken relative to other conditions because the soluble content of a sample can be influenced by factors like different pH of an aqueous solution.

Reference to “waxy” starch refers to starch from plants (e.g. waxy corn, waxy potato, waxy tapioca, waxy rice, etc.) that make starch granules without amylose. Such starches may also be called amylopectin starches because the starch granule consists or consists essentially of amylopectin (have about 0% amylose).

Use of “about” to modify a number in this specification is meant to include the number recited plus or minus 10%. Where legally permissible recitation of a value in a claim means about the value. Use of about in a claim or in the specification is not intended to limit the full scope of covered equivalents.

Use of “essentially” to modify a number, for example essentially 0, is meant to include minimal amounts of contaminant below a specifically recited amount. The amount of contaminant may or may not be measurable.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology is further described in the following aspects, which are intended to be illustrative, and are not intended to limit the full scope of the claims and their equivalents.

In a first aspect, the technology disclosed in this specification pertains to a powdered chickpea-protein based emulsifier comprising: a) a soluble chickpea protein in an amount by weight of the emulsifier of from about 5% to about 40%, or about 10% to about 30%, or about 10% to about 25%; or about 15% to about 25% and b) a gelatinized amylopectin in an amount of from about 30% to about 80%, or from about 30% to 60%, or from about 30% to about 50%, or from about 35% to about 45%, or from about 40% to about 45%; wherein the soluble chickpea protein is not hydrolyzed, and wherein the emulsifier is obtained or obtainable by drying the amylopectin and the chickpea protein together.

In a second aspect, the technology disclosed in this specification pertains to the powdered chickpea-protein based emulsifier of the first aspect wherein the soluble chickpea protein is in an amount from about 5% to about 15, or from about 5% to about 10% and the gelatinized amylopectin is in an amount from about 70% to about 80%.

In a third aspect, the technology disclosed in this specification pertains to the powdered chickpea-protein based emulsifier of the first or second aspects wherein the soluble chickpea protein and gelatinized amylopectin make up from about 40% to about 95% (by weight) of the emulsifier, or from about 40% to about 70%, or about 50% and about 70%, or from about 55% and about 70%.

In a fourth aspect, the technology disclosed in this specification pertains to the powdered chickpea-protein based emulsifier of any one of the first to third aspects wherein the soluble chickpea protein and gelatinized amylopectin make up between about 80% and about 90% (by weight) of the emulsifier.

In a fifth aspect, the technology disclosed in this specification pertains to the powdered chickpea-protein based emulsifier of any one of the first to fourth aspects wherein the amylopectin is from a waxy starch or waxy starch, wherein optionally, the starch is selected from the group consisting of waxy corn starch, waxy tapioca starch, waxy potato starch, and waxy rice starch.

In a sixth aspect, the technology disclosed in this specification pertains to the powdered chickpea-protein based emulsifier of any one of the first to fifth aspects wherein the amylopectin is not modified other than being gelatinized.

In a seventh aspect, the technology disclosed in this specification pertains to the powdered chickpea-protein based emulsifier of any one of the first to sixth aspects consisting essentially the soluble chickpea protein, gelatinized amylopectin and a third component being derived from a chickpea.

In an eighth aspect, the technology disclosed in this specification pertains to the powdered chickpea-protein based emulsifier of any one of the first to seventh aspects consisting of soluble chickpea protein, gelatinized amylopectin and one or more additional components derived from a chickpea.

In a ninth aspect, the technology disclosed in this specification pertains to the powdered chickpea-protein based emulsifier of any one of the first to eighth aspects obtained or obtainable by a process comprising: a) obtaining an aqueous mixture of the chickpea protein and the gelatinized amylopectin; and b) drying the mixture.

In a tenth aspect, the technology disclosed in this specification pertains to the powdered chickpea-protein based emulsifier of any one of the first to ninth aspects obtained by a processes wherein the aqueous mixture is dried by spray drying.

In an eleventh aspect, the technology disclosed in this specification pertains to the powdered chickpea-protein based emulsifier of any one of the first to tenth aspects obtained by a process wherein the aqueous mixture is dried by drum drying.

In a twelfth aspect, the technology disclosed in this specification pertains to the powdered chickpea-protein based emulsifier of any one of the first to eleventh aspects obtained by a process wherein step a) is obtained by mixing aquafaba with amylopectin from a source other than chickpea.

In a thirteenth aspect, the technology disclosed in this specification pertains to the powdered chickpea-protein based emulsifier of any one of the first to twelfth aspects obtained by a process further comprising heating aquafaba and amylopectin to gelatinize the amylopectin.

In a fourteenth aspect, the technology disclosed in this specification pertains to the powdered chickpea-protein based emulsifier of any one of the first to thirteenth aspects obtained by a process wherein the aquafaba and amylopectin are heated at a temperature of from about 90° C. to about 100° C. for at least about 15 minutes, or at about least 20 minutes.

In a fifteenth aspect, the technology disclosed in this specification pertains to the powdered chickpea-protein based emulsifier of any one of the first to fourteenth aspects obtained by a process wherein the aqueous mixture of the soluble chickpea protein and the gelatinized amylopectin is not heated prior to drying.

In a sixteenth aspect, the technology disclosed in this specification pertains to a method of making a powdered chickpea-protein based emulsifier comprising: a) obtaining an aqueous mixture having from about 1% to about 3% soluble chickpea protein and the from about 2% to about 20% gelatinized amylopectin; and b) drying the mixture wherein, optionally, the amount of gelatinized amylopectin is used in an amount selected from a group consisting of: (i) from about 2% to about 5% or from about 2% to about 3% or from about 3% to about 4%; and (ii) from about 10% to about 20% or from about 12% to about 16%, or from about 13% to about 15%; and wherein the soluble chickpea protein is not hydrolyzed.

In a seventeenth aspect, the technology disclosed in this specification pertains to the method sixteenth aspect wherein the amount of gelatinized amylopectin in the aqueous mixture is from about 2% to about 5% or from about 2% to about 3% or from about 3% to about 4%; wherein the aqueous mixture is dried by spray drying; and wherein, optionally, the mixture, before spray drying has solids content of from about 8 to about 11%, or about 9% to about 10%.

In an eighteenth aspect, the technology disclosed in this specification pertains to the method of the sixteenth or seventeenth aspects wherein the amount of gelatinized amylopectin in the aqueous mixture is from about 10% to about 20% or from about 12% to about 16%, or from about 13% to about 15%; wherein the aqueous mixture is dried by drum drying; wherein, optionally, the total solids content is from about 15% to about 25% or from about 17% to about 22%.

In a nineteenth aspect, the technology disclosed in this specification pertains to the method of any one of the sixteenth to eighteenth aspects wherein step a) is obtained by mixing aquafaba with amylopectin from a source other than chickpea.

In a twentieth aspect, the technology disclosed in this specification pertains to the method of any one of the sixteenth to nineteenth aspects further comprising heating the mixture of aquafaba and amylopectin to gelatinize the amylopectin.

In a twenty-first aspect, the technology disclosed in this specification pertains to the method of any one of the sixteenth to twentieth aspects wherein the aquafaba and amylopectin are heated at a temperature of from about 90° C. to about 100° C. for at least about 15 minutes, or at about least 20 minutes.

In a twenty-second aspect, the technology disclosed in this specification pertains to the method of any one of the sixteenth to twenty-first aspects wherein the aqueous mixture of the soluble chickpea protein and the gelatinized amylopectin is not heated prior to drying.

In a twenty-third aspect, the technology disclosed in this specification pertains to the method of any one of the sixteenth to twenty-second aspects wherein the soluble chickpea protein is not heated in the presence of the gelatinized amylopectin.

In a twenty-fourth aspect, the technology disclosed in this specification pertains to the method of any one of the sixteenth to twenty-third aspects wherein the aqueous mixture of the soluble chickpea protein is not denatured in the presence of the gelatinized amylopectin prior to drying.

In a twenty-fifth aspect, the technology disclosed in this specification pertains to a powdered chickpea-protein based emulsifier as described in any foregoing claimed obtained by the process of any one of the foregoing processes.

In a twenty-sixth aspect, the technology disclosed in this specification pertains to a method of making an oil-in-water emulsion comprising: mixing: a) a powdered chickpea-protein based emulsifier as described in any foregoing claim in an amount from about 1% to about 4%, or from about 1% to about 3% or from about 1% to about 2%, or from about 1.5% to 2% by weight of the emulsion; b) oil in an amount selected from the group consisting of i) greater than about 65% or greater than about 70% from about 70% to about 80%, or from about 70% to about 75% and ii) or less than about 50% or from about 25% to about 50% or from about 25% to about 40% or from about 25% to about 35%; and c) an aqueous ingredient to form the emulsion wherein the emulsion is egg free; and wherein the soluble chickpea protein is not hydrolyzed.

In a twenty-seventh aspect, the technology disclosed in this specification pertains to the method the twenty-sixth aspects wherein the powdered chickpea-protein based emulsifier as described in any foregoing claim is mixed in an amount from about 3% to about 4% by weight of the emulsion.

In a twenty-eighth aspect, the technology disclosed in this specification pertains to the method of the twenty-sixth or twenty-seventh aspects wherein a gum or is not added to the emulsion.

In a twenty-ninth aspect, the technology disclosed in this specification pertains to the method of any one of the twenty-sixth to twenty-eighth aspects wherein the only emulsifier in the emulsion are one or more components of the powdered chickpea-protein based emulsifier.

In a thirtieth aspect, the technology disclosed in this specification pertains to the method of any one of the twenty-sixth or twenty-ninth aspects wherein the aqueous ingredient has a pH of less than 7 or less than about 6 or from about 3 to about 6.

In a thirty-first aspect, the technology disclosed in this specification pertains to the method of any one of the twenty-sixth to thirtieth aspects wherein the emulsion obtained has a mean oil droplet size from about 10 microns to about 20 microns, or from about 10 microns to about 17 microns or from about 10 microns to about 15 microns.

In a thirty-second aspect, the technology disclosed in this specification pertains to the method of any one of the twenty-sixth to thirty-first aspects wherein the emulsion obtained has a has a variation of a mean oil droplet size of less that changes by less than about 12.5% or, about less than 10%, or less than about 7%, or less than about 5%, or less than about 2% over 1 month's or 6 month's or 1 year's storage at one or more of 5° C. or 25° C.

In a thirty-third aspect, the technology disclosed in this specification pertains to the method of any one of the twenty-sixth to thirty-second aspects wherein the emulsion obtained has a variation of a mean oil droplet size that changes by less than about 5 microns over 6 months or 1 year when stored at one or more of 5° C. or 25° C.

In a thirty-fourth aspect, the technology disclosed in this specification pertains to the method of any one of the twenty-sixth to thirty-third aspects wherein the powdered chickpea-protein based emulsifier is mixed with an aqueous ingredient prior to mixing with oil.

In a thirty-fifth aspect, the technology disclosed in this specification pertains to the method of any one of the twenty-sixth to thirty-fourth aspects wherein the powdered chickpea-protein based emulsifier is mixed with the aqueous ingredient prior to mixing with oil.

In a thirty-sixth aspect, the technology disclosed in this specification pertains to the use of a powdered chickpea-protein based emulsifier as described in any foregoing claim in a food composition.

In a thirty-seventh aspect, the technology disclosed in this specification pertains to the use of a powdered chickpea-protein based emulsifier as described in the thirty-sixth aspect wherein the food composition is oil-in-water emulsion; wherein the emulsion is egg free.

In a thirty-eighth aspect, the technology disclosed in this specification pertains to the use of a powdered chickpea-protein based emulsifier as described in the thirty-sixth or thirty-seventh aspects wherein the food composition is an oil in water emulsion having oil content (by weight of the emulsion of at least about 70%, or at least about 75%, or from about 70% to about 80%). In a thirty-ninth aspect, the technology disclosed in this specification pertains to the use of a powdered chickpea-protein based emulsifier as described in any one of the thirty-sixth to thirty-eighth aspects in an amount of selected from the group consisting of: a) from about 1% to about 4%, or from about 1% to about 3%, or from about 1% to about 2%, or from about 1.5% to about 2% by weight of the emulsion, and b) or from about 3% to about 4% by weight of the emulsion.

In a fortieth aspect, the technology disclosed in this specification pertains to the use of a powdered chickpea-protein based emulsifier as described in any one of the thirty-sixth to thirty-ninth aspects wherein the emulsion has a mean oil droplet size from about 10 microns to about 20 microns, or from about 10 microns to about 17 microns or from about 10 microns to about 15 microns.

In a forty-first aspect, the technology disclosed in this specification pertains to the use of a powdered chickpea-protein based emulsifier as described in any one of the thirty-sixth to fortieth aspects to stabilize the emulsion against separating over a period of up to about 1 months, or six months or one year.

In a forty-second aspect, the technology disclosed in this specification pertains to the use of a powdered chickpea-protein based emulsifier as described in any one of the thirty-sixth to forty-first aspects wherein the emulsion stability is determined by a variation of mean oil droplet size within the oil in water emulsion of less that about 5 microns over 6 months' or 1 year's storage.

In a forty-third aspect, the technology disclosed in this specification pertains to the use of a powdered chickpea-protein based emulsifier as described in any one of the thirty-sixth to forty-second aspects to stabilize the emulsion against separating over a period of up to about 6 months or 1 year.

In a forty-forth aspect, the technology disclosed in this specification pertains to the use of a powdered chickpea-protein based emulsifier as described in any one of the thirty-sixth to forty-third aspects wherein the emulsion has a variation of a mean oil droplet size that changes by less than about 5 microns over a period 6 months or 1 year when stored at one or more of 5° C. or 25° C.

In a forty-fifth aspect, the technology disclosed in this specification pertains to the use of a powdered chickpea-protein based emulsifier as described in any one of the thirty-sixth to forty-first aspects wherein the emulsion does not comprise a gum.

In a forty-sixth aspect, the technology disclosed in this specification pertains to the use of a powdered chickpea-protein based emulsifier as described in any one of the thirty-sixth to forty-fifth aspects wherein the only emulsifier in the emulsion are one or more components of the powdered chickpea-protein based emulsifier.

In a forty-seventh aspect, the technology disclosed in this specification pertains to a powdered chickpea-protein based emulsifier comprising: a) a soluble chickpea protein in an amount by weight of the emulsifier of from about 5% to about 40%, or about 10% to about 30%, or about 10% to about 25%; or about 15% to about 25% and b) a gelatinized but otherwise unmodified amylopectin in an amount of from about 30% to about 80%, or from about 30% to 60%, or from about 30% to about 50%, or from about 35% to about 45%, or from about 40% to about 45%; wherein the soluble chickpea protein is not hydrolyzed; and wherein the emulsifier is obtained or obtainable by drying the amylopectin and the chickpea protein together wherein, optionally, powdered chickpea-protein based emulsifier of claim 1 wherein the soluble chickpea protein is in an amount from about 5% to about 15, or from about 5% to about 10% and the gelatinized amylopectin is in an amount from about 70% to about 80% wherein, optionally, the amylopectin is from a waxy starch wherein optionally, the starch is selected from the group consisting of waxy corn starch, waxy tapioca starch, waxy potato starch, and waxy rice starch.

In a forty-eighth aspect, the technology disclosed in this specification pertains to the powdered chickpea-protein based emulsifier of the forty-seventh aspect wherein the soluble chickpea protein and gelatinized amylopectin make up from about 40% to about 95% (by weight) of the emulsifier, or from about 40% to about 70%, or about 50% and about 70%, or from about 55% and about 70% wherein, optionally, the soluble chickpea protein and gelatinized amylopectin make up between about 80% and about 90% (by weight) of the emulsifier.

In a forty-ninth aspect, the technology disclosed in this specification pertains to the powdered chickpea-protein based emulsifier of the forty-seventh or forty-eighth aspects wherein the amylopectin is not modified other than being gelatinized.

In a fiftieth aspect, the technology disclosed in this specification pertains to the powdered chickpea-protein based emulsifier of any one of the forty-seventh to forty-ninth aspects consisting essentially the soluble chickpea protein, gelatinized amylopectin and one or more additional components derived from a chickpea.

In a fifty-first aspect, the technology disclosed in this specification pertains to the powdered chickpea-protein based emulsifier of any one of claims the forty-seventh to fiftieth aspects consisting of soluble chickpea protein, gelatinized amylopectin and one or more additional components derived from a chickpea.

In a fifty-second aspect, the technology disclosed in this specification pertains to a method of making a powdered chickpea-protein based emulsifier comprising: a) obtaining an aqueous mixture having from about 1% to about 3% soluble chickpea protein and from about 2% to about 20% gelatinized but otherwise unmodified amylopectin; and b) drying the mixture wherein, optionally, the amount of gelatinized amylopectin is used in an amount selected from a group consisting of: (i) from about 2% to about 5% or from about 2% to about 3% or from about 3% to about 4%; and (ii) from about 10% to about 20% or from about 12% to about 16%, or from about 13% to about 15%; and wherein the soluble chickpea protein is not hydrolyzed wherein, optionally, step a) is obtained by mixing aquafaba with amylopectin from a source other than chickpea.

In a fifty-third aspect the technology disclosed in this specification pertains to the method of the fifty-second aspect wherein the amount of gelatinized amylopectin in the aqueous mixture is from about 2% to about 5% or from about 2% to about 3% or from about 3% to about 4%; wherein the aqueous mixture is dried by spray drying; and wherein, optionally, the mixture, before spray drying, has solids content of from about 8 to about 11%, or about 9% to about 10%.

In a fifty-fourth aspect, the technology disclosed in this specification pertains to the method of the fifty-second or fifty-third aspects wherein the amount of gelatinized amylopectin in the aqueous mixture is from about 10% to about 20% or from about 12% to about 16%, or from about 13% to about 15%; wherein the aqueous mixture is dried by drum drying; and wherein, optionally, the total solids content is from about 15% to about 25% or from about 17% to about 22%.

In a fifty-fifth aspect, the technology disclosed in this specification pertains to the method of any one of the fifty-second to fifty-fourth aspects further comprising heating the aqueous mixture. wherein, optionally, the mixture is heated at a temperature of from about 90° C. to about 100° C. for at least about 15 minutes, or at about least 20 minutes.

In a fifty-sixth aspect, the technology disclosed in this specification pertains to the method of any one of claims fifty-second to fifty-fifth aspects wherein the aqueous mixture of the soluble chickpea protein and the gelatinized amylopectin is not heated prior to drying.

In a fifty-seventh aspect, the technology disclosed in this specification pertains to the method of any one of claims fifty-second to fifty-sixth aspects wherein the soluble chickpea protein is not heated in the presence of the gelatinized amylopectin.

In a fifth-eighth aspect, the technology disclosed in this specification pertains to the method of any one of the fifty-second to fifty-seventh aspects wherein the aqueous mixture of the soluble chickpea protein is not denatured in the presence of the gelatinized amylopectin prior to drying.

In a fifty-ninth aspect, the technology disclosed in this specification pertains to a powdered chickpea-protein based emulsifier as described in any foregoing claimed obtained by the process of any foregoing processes.

In a sixtieth aspect, the technology disclosed in this specification pertains to a method of making an oil-in-water emulsion comprising: mixing: a) a powdered chickpea-protein based emulsifier as described in any foregoing claim in an amount from about 1% to about 4%, or from about 1% to about 3% or from about 1% to about 2%, or from about 1.5% to 2% by weight of the emulsion; b) oil in an amount selected from the group consisting of i) greater than about 65% or greater than about 70% from about 70% to about 80%, or from about 70% to about 75% and ii) or less than about 50% or from about 25% to about 50%, or from about 25% to about 40% or from about 25% to about 35%; and c) an aqueous ingredient to form the emulsion wherein the emulsion is egg free; and wherein the soluble chickpea protein is not hydrolyzed.

In a sixty-first aspect, the technology disclosed in this specification pertains to the method of the sixtieth aspect wherein the powdered chickpea-protein based emulsifier as described in any foregoing claim is mixed in an amount from about 3% to about 4% by weight of the emulsion.

In a sixty-second aspect, the technology disclosed in this specification pertains to the method of any one of the sixtieth to sixty-first aspects wherein the only emulsifier in the emulsion are one or more components of the powdered chickpea-protein based emulsifier.

In a sixty-third aspect, the technology disclosed in this specification pertains to the method of any one of the sixtieth to sixty-second aspects wherein the emulsion obtained has a mean oil droplet size from about 10 microns to about 20 microns, or from about 10 microns to about 17 microns or from about 10 microns to about 15 microns.

In a sixty-fourth aspect, the technology disclosed in this specification pertains to the method of any one the sixtieth to sixty-third aspects, wherein the emulsion obtained has a variation of a mean oil droplet size that changes by less than about 5 microns over 6 months or 1 year when stored at one or more of 5° C. or 25° C.

In a sixty-fifth aspect, the technology disclosed in this specification pertains to the method of any one of the sixtieth to sixty-fourth aspects wherein the powdered chickpea-protein based emulsifier is mixed with an aqueous ingredient prior to mixing with oil.

In a sixty-sixth aspect, the technology disclosed in this specification pertains to use of a powdered chickpea protein-based emulsifier as described in any foregoing claim to make an emulsion as described in any foregoing claim.

### EXAMPLE 1—FORMULATIONS

Table 1 discloses a non-limiting formula for a low-fat emulsion.

TABLE 1
Low-fat emulsion formula: Formula 1

| Paste Ingredients | wt. % |
|---|---|
| Water | 43.0925 |
| Sugar | 11.51 |
| Vinegar (120 Grain) | 8.13 |
| Dry thermally inhibited starch | 4.5 |
| Dry plant-based emulsifier (solids | 1.0 |
| content of protein and amylopectin)) | |
| Salt | 1.69 |
| Preservatives | 0.0775 |
| Soybean Oil | 30.00 |
| Total | 100 |

Note that within low fat emulsions, viscosity that is lost by fact is provided use of thermally inhibited starches. In this case the thermally inhibited starch is used to provide soluble amylopectin. Commonly more highly inhibited thermally inhibited waxy starches would be used because they better resist gelatinization and dissolution in an acidic emulsion. So these highly insoluble thermally inhibited starches are better able to supply viscosity to the emulsion, which is a different effect than providing stability against oil and water separation as is done by dissolved amylopectin.

Table 2 disclose a non-limiting formula for a high fat emulsion.

TABLE 2
High-fat emulsion: Formula 2

| Ingredient | wt. % |
|---|---|
| Water | 3.2 |
| Sugar | 3 |
| Vinegar (120 Grain) | 3 |
| Potassium Sorbate | 0.1 |
| Gelatinized starch | 0.7 |
| Salt | 1 |
| Plant based emulsifier (liquid) | 18 |
| Soybean Oil | 71 |
| Total | 100 |

Note that within high fat emulsions the starch is added as dry basis. The starches used are as specifically described. Emulsions made using liquid plant-based emulsifier and dry starch are provided to illustrate the improved stability, be references to the changes in mean oil droplet size in time, of emulsions as dissolved amylopectin content increases.

### EXAMPLE 2—PROCEDURES

Viscosity was measured using a Brookfield DV2T w/heliopath moving upward using a T spindle C for 30 seconds at 20 RPM.

Droplet size was measured using a Beckman Coulter LS 13 320 SW Laser Based Particle Size Analyzer.

Soluble content of a solutions was measured using a polarimeter, e.g. Autopol IV Automatic Polarimeter, Rudolph Research Analytical, Flanders, NJ.

Protein content of a solution or emulsion can be found using any one of various nitrogen content calculations known in the art, for example, using a Dumas calculation method using a LECO analyzer.

Total solids content is determined by measuring the initial weight of a 1 gram sample of solution containing a starch, measuring the residue remaining after drying the sample at 130° C. for 4 hours, and comparing the weights of the initial sample and the dried residual sample. Percent solids content is the weight of residual sample/initial sample weight×100.

Emulsions were made by first blending all dry ingredients. Water and vinegar were combined in a conventional kitchen stand mixer mixing bowl. The dry blend was added to the water and vinegar mixture and mixed until homogenous. Oil was slowly added while mixing at medium speed. The mass was then transferred to a Scott Turbon mixer for high shear homogenization. (30 hertz for 2 minutes).

### EXAMPLE 3—LONG TERM STABILITY OF HIGH-FAT EMULSIONS

The long-term stability of various emulsions made with different starches was evaluated. High-fat emulsions were made using two variants of thermally inhibited starches, a highly inhibited waxy corn starch, and an intermediately inhibited waxy corn starch available from Ingredion Incorporated. To cook them, the thermally inhibited starches were dispersed in an aqueous solution in a container and the dispersion was cooked in hot water bath for 10 minutes at 210° F. (about 99° C.). Cooked starch dispersions were cooled for at least 12 hours before used to make emulsions. The cooked starches were used to make the high-fat emulsions described in the formula of Table 2 and were made using the process of Example 2. The emulsions were placed in jars for storage at room temperature (25° C.) or refrigerated (5° C.) and the mean oil droplet sizes were determined at different time points after storage.

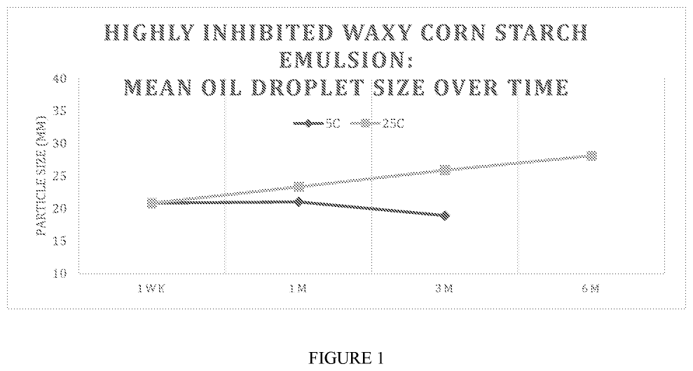

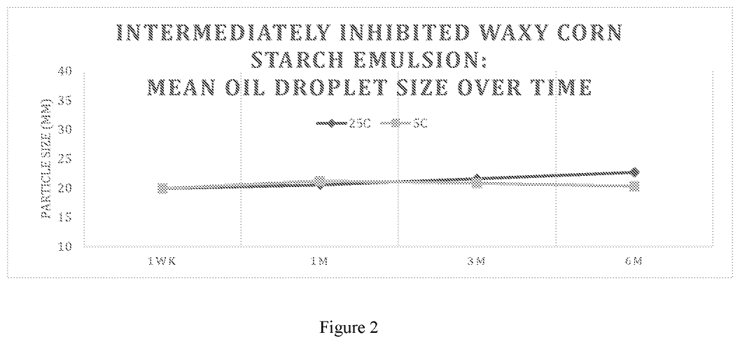

The results of tests of the long-term stability of the emulsions are reported in FIGS. 1 and 2, where it is seen that emulsions made with the intermediately thermally inhibited waxy corn starch had much less variation in mean oil droplet size over time compared to emulsions made with the highly thermally inhibited waxy corn starch. It is believed that the observed increased stability results from a stabilization effect provided by more amylopectin being dissolved in the aqueous phase of emulsions using less thermally inhibited waxy corn starch.

### EXAMPLE 4—SOLUBLE CONTENT OF VARIOUS COOKED WAXY STARCHES

To show the effect that amylopectin dissolved in the aqueous phase of an emulsion has on the stability of the emulsion against oil and water separation the soluble content of various cooked starches. Soluble starch was obtained by gelatinizing various waxy corns starches and the percent soluble content of a starch samples reflects the completeness of gelatinization. More gelatinized starch has more soluble waxy starch.

The soluble content of dispersions of cooked starch was measured as follows. In a glass beaker, 2 grams of starch was added to an aqueous solution buffered to either pH 6 or pH 3 to make a 100 g dispersion. Starch was dispersed in solution using mixer. The solution was continuously mixed during cooking in a stoppered beaker submerged in boiling water bath (100° C.) for 20 minutes. The dispersion was then allowed to cool for 1 hour. Samples were removed from beaker and diluted to 1% using buffered solution (same as for initial dispersion). Starch in dispersion was transferred to graduated cylinder and allowed to settle for up to 72 hours (until swelling of starch stopped). Drops of supernatant were removed and measured for soluble material content using a polarimeter.

Using the above described method, the soluble content of waxy corn starch, intermediately thermally inhibited waxy corn starch and highly thermally inhibited waxy corn starch were determined. The results are reported in Table 3 below.

TABLE 3
Soluble Content of Various Waxy Corn Starches

| | Solution | Soluble Content |
|---|---|---|
| Starch | pH | (%) |
| Waxy Corn starch | 6 | 50.0 |
| | 3 | 50.0 |
| Intermediately inhibited, thermally | 6 | 8.0 |
| inhibited waxy corn starch | 3 | 17.0 |
| Highly inhibited, thermally | 6 | 6.6 |
| inhibited waxy corn starch | 3 | 10.8 |
| Lowly inhibited, thermally | 6 | 1.4 |
| inhibited waxy tapioca starch | 3 | 6.5 |
| Intermediately inhibited, | 6 | 1.2 |
| thermally inhibited waxy | 3 | 8.7 |
| tapioca starch | | |
| Highly inhibited, thermally | 6 | 1.2 |
| inhibited waxy tapioca starch | 3 | 19.0 |

As shown, uninhibited starches and less thermally inhibited waxy starches have higher soluble amylopectin content in all cases, but particularly so at low pH (pH 6 vs pH 3). Starches can be inhibited to varying degrees according to the methods described in WO95/04082. It should be noted that the absolute degree of inhibition is not relevant other to show that less inhibited starches have higher soluble starch content, which because the starches are waxy starches the starch is entirely amylopectin. As shown herein, emulsions made with higher amounts of dissolved e amylopectin have smaller mean droplet size than emulsion with less dissolved amylopectin. For example this can be seen with reference to FIGS. 1 and 2 it shown, therefore, that emulsions having higher soluble amylopectin content were more stable over time.

### EXAMPLE 5—MEAN OIL DROPLET SIZE OF EMULSIONS MADE WITH VARIOUS COOKED WAXY STARCHES

The quality of an emulsion can also be assessed by measuring the mean size of oil droplets in the emulsion under high magnification. It is known that higher quality, more stable emulsions generally having a smaller mean oil droplet size—in a sense the oil is less coalesced when mean oil droplet size is smaller. Mean oil droplet size of oil-in-water emulsions was evaluated for seven emulsions made using one of a waxy corn starch or waxy cassava starch as described and processed as below. The emulsions were high-fat emulsions as described in the formula of Table 2. The emulsions were made according to the process of Example 2.

Sample 1 used a native waxy corn starch that was pregelatinized by spray cooking. Sample 2 used an intermediately inhibited, thermally inhibited waxy corn starch that was pregelatinized by spray cooking. Sample 3 used an intermediately inhibited, thermally inhibited waxy corn starch that is pregelatinized by spray cooking and then further cooked. Sample 4 used an intermediately inhibited, thermally inhibited waxy corn starch that is pregelatinized by spray cooking and then further cooked and sheared. Sample 5 used a highly inhibited, thermally inhibited waxy tapioca starch. Sample 6 used an intermediately inhibited, thermally inhibited waxy tapioca starch. Sample 7 used a lowly inhibited, thermally inhibited waxy tapioca starch.

The mean oil droplet size of fresh oil-in-water emulsions and the viscosity of fresh oil in water emulsions were measured and reported in Table 4 below.

TABLE 4
Oil Droplet Size and Viscosity of Oil-in-
Water Emulsions Using Different Starches

| | | | Mean Oil |
|---|---|---|---|
| | | | Droplet Size |
| Sample | Starch Type | Viscosity (cP) | (μM) |
| 1 | Spray cooked waxy corn starch | 16850 | 10.95 |
| 2 | Spray cooked, intermediately | 35100 | 21.10 |
| | inhibited, thermally | | |
| | inhibited waxy corn starch | | |
| 3 | Cooked, spray cooked, | 34050 | 17.66 |
| | intermediately inhibited | | |
| | waxy corn starch | | |
| 4 | Cooked, sheared, spray cooked, | 22600 | 14.48 |
| | intermediately inhibited | | |
| | waxy corn starch | | |
| 5 | Cooked, highly inhibited | 27150 | 16.85 |
| | waxy tapioca starch | | |
| 6 | Cooked, intermediately inhibited | 28100 | 19.86 |
| | waxy tapioca starch | | |
| 7 | Cooked, lowly inhibited | 23450 | 13.85 |
| | waxy tapioca starch | | |

Table 4 shows that emulsions having the smallest droplet size also generally had starches most likely to be subjected to the greatest degree of degradation by processing. Sample 1, for example used native starch. Other samples used thermally inhibited starches (all available from Ingredion Incorporated). Notably, thermally inhibit starches are physically modified to be process tolerant, with more highly thermally inhibited starches being more process tolerant than less thermally inhibited starches. For example, among Samples 2 through 4, it is seen that Sample 4, the most harshly pretreated, being spray cooked, further cooked, and sheared, and so most likely to release amylopectin during emulsion, has the smallest droplet size. Among Samples 5 to 7, it is further seen that the Sample 7 the least inhibited starch, and, per Table 3, having the least soluble amylopectin of samples 5 to 7 also has the lowest mean oil droplet size.

This shows that emulsions that had the most dissolved amylopectin in their aqueous phase had the smallest mean oil droplet size.

### EXAMPLE 6—EMULSIONS MADE FROM POWDER PLANT-BASED PROTEIN EMULSIFIERS

The improved stability of emulsions using an unhydrolyzed soluble chickpea protein and amylopectin dissolved in the aqueous phase is further explored seeing how drying the mixture of soluble protein and dissolved amylopectin affects emulsion stability against oil and water separation.

Spoonable salad dressings based on oil-in-water emulsions were used as a bench mark for the evaluating the emulsifying capability of powdered chickpea-protein based emulsifiers. Formulas used are listed in Table 5.

TABLE 5
Formulas: Spoonable Dressing

| | | | Formula 4 | | Formula 5 | |
|---|---|---|---|---|---|---|
| | Formula 3 | | Powdered Chickpea | | Powdered Chickpea | |
| | Liquid Chickpea Protein | | Protein Emulsifier | | Protein Emulsifier | |
| | Emulsifier (no Starch) | | (Spray dried) | | (Convection dried) | |
| Ingredient | wt. % | g | wt. % | g | wt. % | g |
| Water | 0 | 0 | 16.2 | 324 | 42.7 | 854 |
| Sugar | 3 | 60 | 3 | 60 | 3 | 60 |
| Vinegar | 3 | 60 | 3 | 60 | 3 | 60 |
| Potassium Sorbate | 0.1 | 2 | 0.1 | 2 | 0.1 | 2 |
| Dry Starch | 0 | 0 | 0 | 0 | 1.7 | 34 |
| Salt | 1 | 20 | 1 | 20 | 1 | 20 |
| Emulsifier | 17.9 | 358 | 1.7 | 34 | 3.5 | 70 |
| Soybean Oil | 75 | 1500 | 75 | 1500 | 45 | 900 |
| Total | 100 | 2000 | 100 | 2000 | 100 | 2000 |

Formula 3 is a control formulation using a concentrated aquafaba (steep water from pressure cooked chickpeas and evaporated) that is then rehydrated to obtain a liquid material having about 1% solids content. Formula 4 used a powder, chickpea protein emulsifier obtained by spray drying chickpea protein-based emulsifier. Formula 5 used a powder, chickpea protein-based protein emulsifier obtained by convection drying process intended to mimic a drum drying process. It uses more emulsifier to account for variations in the starch to protein ratio in the dried product, which result from drum drying processes needing higher solids content (provided here by way starch) to form a dry product. Oil content is also reduced in Formula 5 to adjust for the different amylopectin to protein ratio in the dried emulsifier. Furthermore, additional dry starch is added to compensate for the lower viscosity of the emulsion resulting from the reduced oil content.

Note that water was used in Formulas 4 and 5 to rehydrate the powdered chickpea protein-based emulsifier before making the emulsion; the amount of water used was standardized to obtain a 1% solids content aqueous solution, which matches the solids content of the aquafaba used in Formula 3.

The spray dried samples of the powered chickpea-protein based emulsifier used in Formula 4 were made as follows. Liquid chickpea protein-based emulsifier (aquafaba used in Formula 3) and thermally inhibited waxy corn were combined at 3.65% wt. % starch into 96.35% wt. % emulsifier. The mixture was heated to cook out the starch for 20 minutes at 210° F. (about 99° C.), then the moisture was adjusted back to the original weight to compensate for water loss. The mixture was found to be 9.14% solids prior to spray drying inside of a Buchi Mini Spray Dryer B-290. The following settings were used: 155° C. input temperature, ˜95° C. output temperature, 7% pump speed, 97% aspiration.

Convection dried samples of the powdered chickpea-protein based emulsifier were made as follows. Liquid chickpea protein-based emulsifier (aquafaba used in Formula 3) and thermally inhibited waxy corn starch were combined at 14.50% wt. % starch and 85.50% wt. % emulsifier. The mixture was scraped over a stainless-steel surface and exposed to convection heat at 210° F. (about 99° C.) to simulate exposure to the surface of a drum dryer surface. The film was cooked 3-4 hours to produce a dry thin film. The dried material was scraped off and ground to approximately 20 mesh.

Following reconstitution of the of the powder chickpea protein emulsifiers to form a liquid emulsifiers, emulsions were made using Formulas 3, 4, 5. Emulsion Sample 8 was made using Formula 3. Emulsion Sample 9 was made using Formula 4. Emulsion Sample 10 was made using Formula 5. A Sample 11 was also made to compare with Sample 10. Sample 11 used a liquid chickpea protein emulsifier (no gelatinized amylopectin), like Sample 8 (Formula 3). Sample 11 also adjusted the liquid chickpea protein emulsifier usage to match chickpea solids content of Sample 10. Also, Sample 11 increased starch content like Sample 10 (using a separate lightly thermally inhibited starch outside of the powdered chickpea-protein based emulsifier) and 45% oil used.

Samples 7 and 11 were made using the method Example 2. In Samples 9 and 10, the powdered chickpea-protein based emulsifier was first rehydrated, but otherwise the samples were made according to the process of Example 2.

### EXAMPLE 7—CHARACTERISTICS OF EMULSIONS USING REHYDRATED DRUM DRIED, POWDER PLANT BASED PROTEIN EMULSIFIERS

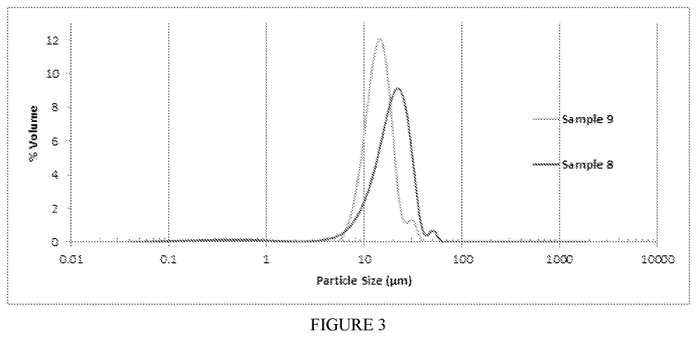

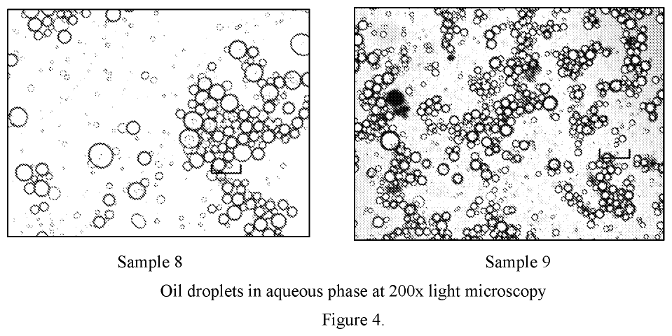

FIG. 3 depicts the droplet size distribution of Sample 8 (Formula 3) and Sample 9 (Formula 4). The difference in oil droplet size distribution is also seen in FIG. 4, which is a picture of the emulsion of using liquid aquafaba (Formula 3) and spray dried aquafaba (Formula 4). The emulsions were measured after 24 hours storage at room temperature. The mean droplet size of Sample 8 was 20.62 μm. The mean droplet size of Sample 9 was 15.45 μm. As shown, the rehydrated spray dried, powder chick pea emulsifier had similar droplet size compared to the samples of Table 4 (using a cooked starch, but non-spray dried liquid chickpea protein emulsifier). This demonstrates that the spray-drying and reconstituting process does not substantially alter the effectiveness of the liquid chickpea emulsifier. It also shows the stabilizing effect of solubilized amylopectin on the emulsion. The difference in droplet size distribution is also depicted in microscopy photographs (light microscopy 200× magnification). The sample in the pictured on left, with generally larger oil droplets is Sample 8. The sample in the picture on the right, with generally smaller oil droplets is Sample 9.

Mean oil droplet size of Samples 10 and 11 was larger than for Samples 8 and 9, likely because of the reduced use of emulsifier. But Sample 10 had a mean droplet size of about 21 microns which is smaller than the mean droplet size of the Sample 11, about 30 microns.

In sum the findings of this examples show that chickpea protein can retain its emulsifying ability in following drying and reconstitution and it shows the stabilizing effect of solubilized amylopectin on the emulsion is not changed by the drying process either.

### EXAMPLE 8 COMPARISON OF POWDER CHICKPEA EMULSION MADE WITH AND WITHOUT SOLUBILIZED AMYLOPECTIN

A final comparative Sample 12 was made using a commercially available aquafaba powder. Sample 12 was a 75% oil in water emulsion made after reconstituting the spray dried chickpea protein to have the same solids content as Samples 9 and 10. The Sample 12's formula was otherwise like formulas 3 and 4. Sample 12 was made by the process of Example 2. Sample 12 was made in duplicate and was measured to have mean particle size of 40.63 μm and the other had mean particle size of 42.21 μm. This demonstrates the importance of soluble amylopectin in the formation of good and stable emulsions.

1. A powdered chickpea-protein based emulsifier comprising:
a) a soluble chickpea protein in an amount by weight of the emulsifier of from about 5% to about 40%, and
b) a gelatinized but otherwise unmodified amylopectin in an amount of from about 30% to about 80%;
wherein the soluble chickpea protein is not hydrolyzed; and
wherein the emulsifier is obtained by drying the amylopectin and the chickpea protein together
wherein the amylopectin is from a waxy starch.

2. The powdered chickpea-protein based emulsifier of claim 1 wherein the soluble chickpea protein and gelatinized amylopectin make up from about 40% to about 95% (by weight) of the emulsifier,

3. The powdered chickpea-protein based emulsifier of claim 1 wherein the amylopectin is not modified other than being gelatinized.

4. The powdered chickpea-protein based emulsifier of claim 1 consisting essentially the soluble chickpea protein, gelatinized amylopectin and one or more additional components derived from a chickpea.

5. The powdered chickpea-protein based emulsifier of claim 1 consisting of soluble chickpea protein, gelatinized amylopectin and one or more additional components derived from a chickpea.

6. A method of making a powdered chickpea-protein based emulsifier comprising:
a) obtaining an aqueous mixture having from about 1% to about 3% soluble chickpea protein and from about 2% to about 20% gelatinized but otherwise unmodified amylopectin; and
b) drying the mixture

7. The method of claim 6 wherein the amount of gelatinized amylopectin in the aqueous mixture is from about 2% to about 5% wherein the aqueous mixture is dried by spray drying; and
wherein the mixture, before spray drying, has solids content of from about 8 to about 11%, or about 9% to about 10%.

8. The method of claim 6 wherein the amount of gelatinized amylopectin in the aqueous mixture is from about 10% to about 20% wherein the aqueous mixture is dried by drum drying; and
wherein the total solids content is from about 15% to about 25%.

9. The method of claim 6 further comprising heating the aqueous mixture at a temperature of from about 90° C. to about 100° C. for at least about 15 minutes.

10. The method of claim 6 wherein the aqueous mixture of the soluble chickpea protein and the gelatinized amylopectin is not heated prior to drying.

11. The method of claim 6 wherein the soluble chickpea protein is not heated in the presence of the gelatinized amylopectin.

12. The method of claim 6 wherein the aqueous mixture of the soluble chickpea protein is not denatured in the presence of the gelatinized amylopectin prior to drying.

13. (canceled)

14. A method of making an oil-in-water emulsion comprising:
mixing: a) a powdered chickpea-protein based emulsifier in an amount from about 1% to about 4%, by weight of the emulsion; b) oil in an amount and c) an aqueous Ingredient to form the emulsion
wherein the oil is in an amount selected from the group consisting of
i) greater than about 65% and
ii) or less than about 50% and
wherein the emulsion is egg free; and
wherein the soluble chickpea protein is not hydrolyzed.

15. Method of claim 14 wherein the powdered chickpea-protein based emulsifier is mixed in an amount from about 3% to about 4% by weight of the emulsion.

16. The method of claim 14 wherein the only emulsifier in the emulsion are one or more components of the powdered chickpea-protein based emulsifier.

17. The method of claim 14 wherein the emulsion obtained has a mean oil droplet size from about 10 microns to about 20 microns.

18. The method of claim 14 wherein the emulsion obtained has a variation of a mean oil droplet size that changes by less than about 5 microns over 6 months when stored at one or more of 5° C. or 25° C.

19. The method of claim 14 wherein the powdered chickpea-protein based emulsifier is mixed with an aqueous Ingredient prior to mixing with oil.

20. (canceled)
